(19) United States
(12) Patent Application Publication
(10) Pub. No.: US 2015/0029079 A1
(43) Pub. Date: Jan. 29, 2015

(54) DRIVE CIRCUIT, DISPLAY DEVICE, AND DRIVE METHOD

(71) Applicant: Japan Display Inc., Tokyo (JP)

(72) Inventors: Toshio MIYAZAWA, Tokyo (JP); Mitsuhide MIYAMOTO, Tokyo (JP)

(73) Assignee: Japan Display Inc.

(21) Appl. No.: 14/339,500

(22) Filed: Jul. 24, 2014

(30) Foreign Application Priority Data
Jul. 26, 2013 (JP) 2013-156170

(51) Int. Cl. G09G 3/32

(52) U.S. Cl. CPC G09G 3/3208; G09G 2310/0289
USPC 345/82; 315/172

(57) ABSTRACT

A drive circuit for a light emitting element small in the number of components which can correct a threshold voltage of a drive transistor is provided. The drive circuit includes a line that is connected between two reference voltages, a light emitting element on the line, a drive transistor on the line, a first capacitor connected between a gate and a drain of the drive transistor, a second capacitor connected between the gate and a source of the drive transistor, a first switching element connected to the gate of the drive transistor and turning on during a signal writing period to supply a signal voltage to the gate of the drive transistor, and a second switching element disposed on the line and having one side connected to the source of the drive transistor, and the second capacitor.

### CROSS-REFERENCE TO RELATED APPLICATION

The present application claims priority from Japanese application JP 2013-156170, filed on Jul. 26, 2013, the content of which is hereby incorporated by reference into this application.

### BACKGROUND OF THE INVENTION

1. Field of the Invention

The present invention relates to a drive circuit for light emitting elements, and a display device having the drive circuit.

2. Description of the Related Art

For example, the light emitting elements such as an organic EL element (OLED) are used for image display. The drive circuit that conducts light emission driving of the light emitting elements with a circuit configuration small in the number of circuit elements is desirable.

FIG. 6 is a circuit diagram of a drive circuit in a related art, and FIG. 7 is a timing chart illustrating a method of driving the drive circuit in the related art. The drive circuit in the related art is the most basic drive circuit including two transistors and one capacitor, and the two transistors illustrated in the figure are each configured by an n-type MOS-TFT (thin film transistor). A transistor NT1 is a drive transistor, and the transistor NT1 and an organic EL element OLED are connected in series between a first reference voltage VD and a second reference voltage VS. A capacitor C1 is connected between a gate and a drain of the transistor NT1. A voltage at the gate of the transistor NT1 is represented by a node N1, and a voltage at a source of the transistor NT1 is represented by a node N2. A transistor NT2 connected between the gate of the transistor NT1 and a signal line SIG is a switching transistor, and a gate of the transistor NT2 is connected to a first control line φ1.

FIG. 7 illustrates a change in the voltages of the signal line SIG, the first control line φ1, the node N1, and the node N2 in time series. When it is assumed that times shown in the figure are times t1 to t7, respectively, a period between the time t3 and the time t4 represents a signal writing period during which a signal voltage Va is written in the organic EL element OLED. Since an on-voltage of the transistor NT2 is a high voltage V_{E}, and an off-voltage of the transistor NT2 is a low voltage V_{L}, a voltage at the first control line φ1 is the high voltage V_{E} in the period between the time t3 and the time t4, and the low voltage V_{L} in other periods. At the time t3, the control line φ1 changes from the low voltage V_{L} to the high voltage V_{E}, the transistor NT2 turns on, the signal voltage Vₐ of the signal line SIG is applied to the node N1 (the gate of the transistor NT1), and the capacitor C1 is charged or discharged. Hence, the node N1 changes from a voltage Vₐₚ before writing to a voltage Vₐ (signal voltage Vₐ) after writing. The node N2 changes from a voltage V₁ₚ before writing to a voltage V₁ after writing.

### SUMMARY OF THE INVENTION

The drive circuit in the related art illustrated in FIG. 6 is configured by the basic circuit small in the number of components, but has no function of correcting variations in characteristics attributable to a variation in a threshold voltage Vₜₕ of the transistor NT1 which is the drive transistor. In particular, when the drive transistor is formed of a low-temperature polysilicon TFT, if the characteristics of the transistor are varied among the drive circuits (pixels) due to a crystal variation of polysilicon to be formed in a process of subjecting a semiconductor layer to laser annealing, display unevenness appears on an image, to thereby lead to the degrading of display quality.

JP 2007-310311 A discloses a drive method for the drive circuit (refer to FIG. 3C) including two transistors and one capacitor. According to the drive method, a threshold voltage of a drive transistor 3B can be corrected. However, during the signal writing period, a potential of a power supply line DSL 101 is varied between a high potential Vcc_H (first potential) and a low potential Vcc_L (second potential), and a length of the substantial writing period is restricted, resulting in a problem that high definition is difficult. Also, when the above drive circuit is set as one pixel, and a plurality of pixels is arranged two-dimensionally, there arises such a problem that shading is generated in a horizontal direction (row of pixels to which a signal is written at the same time). Therefore, in order to realize a display device having the above circuit, a new design is required to suppress the shading to a practicable level.

The present invention has been made in view of the above problems, and an object of the present invention is to provide a drive circuit for light emitting elements small in the number of components, which can correct a threshold voltage of a drive transistor.

(1) According to the present invention, there is provided a drive circuit, including: a first power line and a second power line that two different reference voltages are applied to, respectively; a light emitting element that is disposed between the first power line and the second power line, and allows a current to flow therein to emit a light; a drive transistor that is disposed between the first power line and the second power line, and controls the amount of current flowing into the light emitting element; a first capacitor that is electrically connected between a gate and one of a source and a drain of the drive transistor; a second capacitor that is electrically connected between the gate and the other of the source and the drain of the drive transistor; a first switching element that is electrically connected to the gate of the drive transistor, and turns on during a signal writing period to supply a signal voltage to the gate of the drive transistor; and a second switching element that is disposed between the first power line and the second power line, wherein the drive transistor, the second switching element, and the light emitting element are connected in series.

(2) In the drive circuit according to the above item (1), the second switching element may be in an on-state when the signal writing period starts, turn off a given time after the signal writing period starts, and again turn on in a light emitting period.

(3) In the drive circuit according to the above item (1) or (2), a difference between the first capacitor and the second capacitor may fall within ±10% of the second capacitor.

(4) In the drive circuit according to any one of the above items (1) to (3), the first switching element may be configured by a thin film transistor having a plurality of gate electrodes.

(5) In the drive circuit according to any one of the above items (1) to (4), the drive transistor, the first switching element, and the second switching element have a common polarity.

(6) A display device including the drive circuit according to any one of the above items (1) to (5).

(7) According to the present invention, there is provided a method of driving a drive circuit including: a first line and a second line that two different reference voltages are applied to, respectively; a light emitting element that is disposed between the first power line and the second power line, and allows a current to flow therein to emit a light; a drive transistor that is disposed between the first power line and the second power line, and controls the amount of current flowing into the light emitting element; a first capacitor that is electrically connected between a gate and one of a source and a drain of the drive transistor; a second capacitor that is electrically connected between the gate and the other of the source and the drain of the drive transistor; a first switching element that is electrically connected between the gate of the drive transistor and a signal line; and a second switching element that is disposed between the first power line and the second power line, wherein the drive transistor , the second switching element, and the light emitting element are connected in series, wherein the second switching element is in an on-state when the signal writing period starts, wherein the first switching element turns on, and applies a signal voltage to be applied to the signal line to the gate of the drive transistor during the signal writing period, wherein the second switching element turns off a given time after the signal writing period starts, and wherein the first switching element turns off, and the second switching element turns on in response to a light emitting period.

According to the present invention, there is provided a drive circuit for light emitting elements small in the number of components which can correct a threshold voltage of a drive transistor.

### BRIEF DESCRIPTION OF THE DRAWINGS

FIG. 1 is a diagram illustrating a display device according to a first embodiment of the present invention;

FIG. 2 is a diagram illustrating an equivalent circuit of the display device according to the first embodiment of the present invention;

FIG. 3 is a circuit diagram of a drive circuit according to the first embodiment of the present invention;

FIG. 4 is a timing chart illustrating a method of driving the drive circuit according to the first embodiment of the present invention;

FIG. 5 is a circuit diagram of a drive circuit according to a second embodiment of the present invention;

FIG. 6 is a circuit diagram of a drive circuit in a related art; and

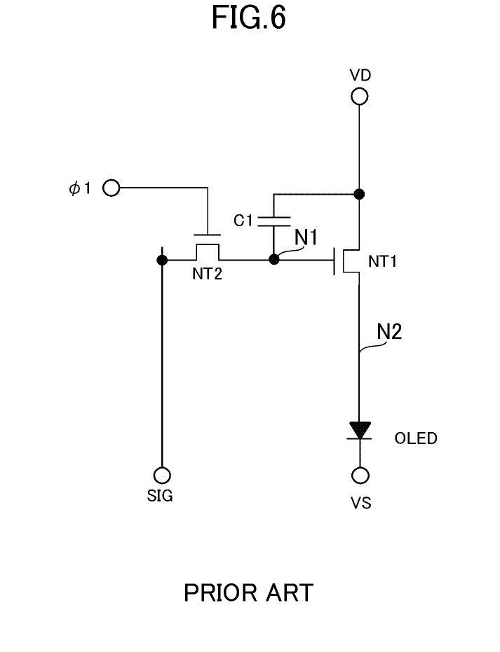

FIG. 7 is a timing chart illustrating a method of driving the drive circuit in the related art.

### DETAILED DESCRIPTION OF THE INVENTION

Hereinafter, embodiments of the present invention will be described specifically and in detail with reference to the accompanying drawings. In all of the drawings for describing the embodiments, members having the same function are denoted by identical symbols, and a repetitive description will be omitted. Also, the drawings described below illustrate the embodiments, and sizes in the drawings do not always match scale sizes described in this embodiment.

### First Embodiment

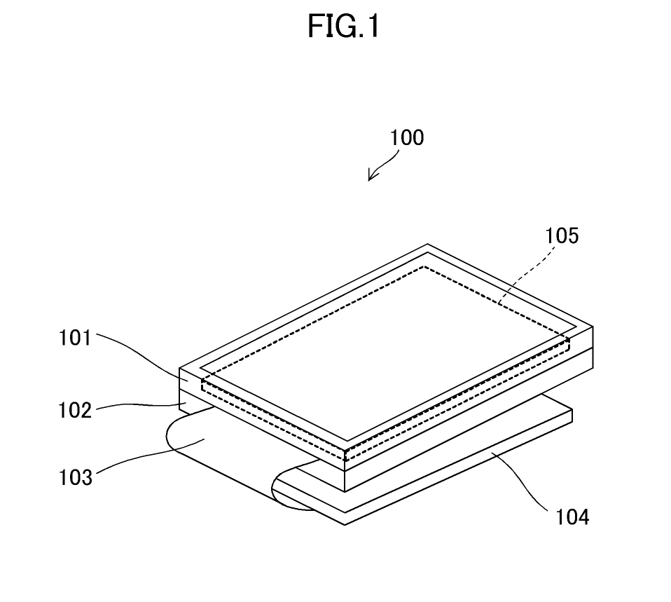

FIG. 1 is a diagram illustrating a display device according to a first embodiment of the present invention. The display device according to this embodiment is an organic EL display device 100 using an organic EL element as a light emitting element. As illustrated in FIG. 1, the organic EL display device 100 includes an upper frame 101 and a lower frame 102 which fix a TFT (thin film transistor) substrate 105 having an organic EL panel therebetween, a circuit board 104 having a circuit element that generates information to be displayed, and a flexible printed circuit 103 (FPC) that transmits information on RGB generated in the circuit board 104 to the TFT substrate 105.

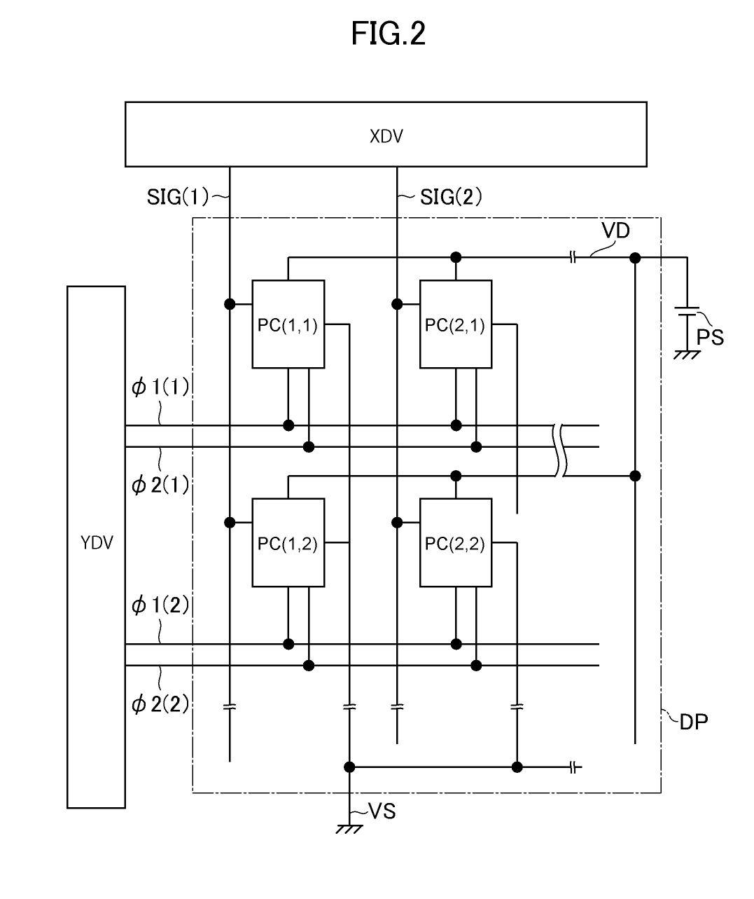

FIG. 2 is a diagram illustrating an equivalent circuit of the display device according to the first embodiment. FIG. 2 illustrates particularly the organic EL panel in the organic EL display device 100. The organic EL panel includes a plurality of signal lines SIG that extend in a longitudinal direction in the figure, and are arranged side by side in a lateral direction, a plurality of first control lines φ1 that extend in the lateral direction in the figure, and are arranged side by side in the longitudinal direction, a plurality of second control lines φ2 that are arranged side by side with the respective first control lines φ1, a plurality of pixel circuits PC arranged in a matrix in correspondence with intersection points between the signal lines

SIG and the first control lines φ1 (second control lines φ2), a signal line drive circuit XDV, and a scanning line driver circuit YDV. The signal lines SIG are connected to the signal line drive circuit XDV at upper ends thereof. The first control lines φ1 and the second control lines φ2 are connected to the scanning line driver circuit YDV. The plurality of pixel circuits PC configure a display area DP. The signal line drive circuit XDV and the scanning line driver circuit YDV drive the respective pixel circuits PC in conjunction with each other.

A voltage source PS supplies a first reference voltage VD to a first power line connected to the voltage source PS, and the first power line is connected to the respective pixel circuits PC. Also, a second power line connected to a ground voltage GND is maintained at a second reference voltage VS, and the second power line is connected to the respective pixel circuits PC. That is, in the first embodiment, the second reference voltage VS is the ground voltage, and the first reference voltage VD is higher than the ground voltage. However, the present invention is not limited to this configuration. Also, FIG. 2 illustrates only four pixel circuits PC of 2×2. However, actually, the pixel circuits PC of the number corresponding to a display resolution are present. In general, a pixel circuit located at n×m is represented by PC(m, n). For example, a pixel circuit located on an upper left is represented by PC (1, 1). Also, a signal line connected to the pixel circuits of an m-th column is represented by SIN(m), and a first control line and a second control line connected to the pixel circuits of the n-th row are represented by φ1 (n) and φ2 (n), respectively.

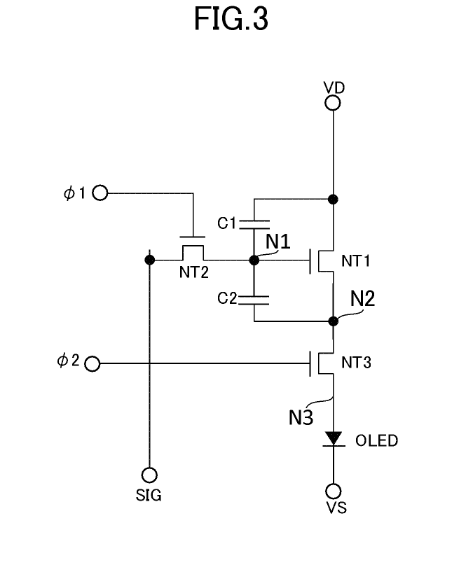

FIG. 3 is a circuit diagram of a drive circuit according to the first embodiment. The drive circuit illustrated in FIG. 3 is a drive circuit for an organic EL element OLED which is a light emitting element, which is the pixel circuit PC illustrated in FIG. 2. The drive circuit according to the first embodiment is a drive circuit including three transistors and two capacitors. The organic EL element OLED is the light emitting element that allows a current to flow therein to emit a light. Each of the three transistors illustrated in the figure is an n-type MOS-TFT. A transistor NT1 is a drive transistor for controlling the amount of current flowing into the organic EL element OLED. A transistor NT2 and a transistor NT3 represent a first switching transistor (first switching element) and a second switching transistor (second switching element), respectively. The transistor NT1, the transistor NT3, and the organic EL element OLED are connected in series in the stated order on a line connected between the first reference voltage VD and the second reference voltage VS. A capacitor C1 which is a first capacitor is connected between a gate and a drain of the transistor NT1, and a capacitor C2 which is a second capacitor is connected between the gate and a source of the transistor NT1. The transistor NT3 is arranged on the second reference voltage VS side (the organic EL element OLED side) of a connection point between the source of the transistor NT1 and the capacitor C2 on the above line. That is, one side (drain side) of the transistor NT3 is connected to both of the source of the transistor NT1 and the capacitor C2. A voltage at the gate of the transistor NT1 is a node N1, a voltage at the source of the transistor NT1 (at a drain of the transistor NT3) is a node N2, and a voltage at a source of the transistor NT3 (at an anode of the organic EL element OLED) is a node N3. The transistor NT2 is connected between the gate of the transistor NT1, and the signal lines SIG. A gate of the transistor NT2 is connected to the first control line φ1.

A gate of the transistor NT3 is connected to the second control lines φ2.

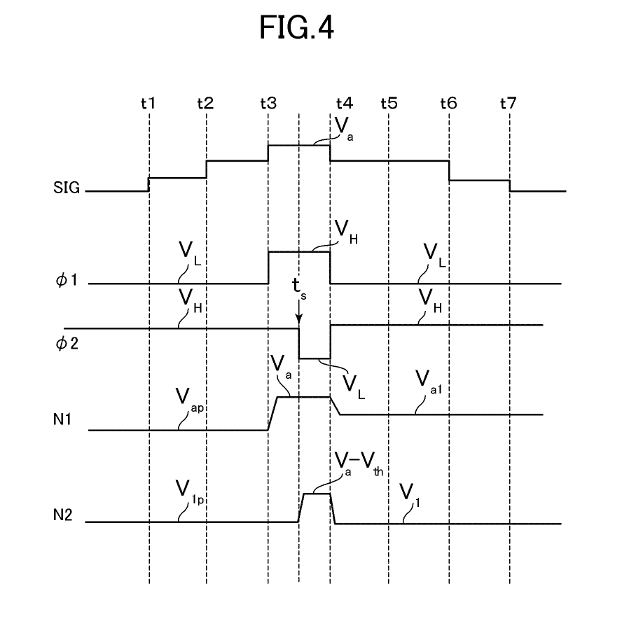

FIG. 4 is a timing chart illustrating a method of driving the drive circuit according to the first embodiment. FIG. 4 illustrates a change in the voltages of the signal line SIG, the first control line φ1, the second control lines φ2, the node N1, and the node N2 in time series. When it is assumed that times shown in the figure are times t1 to t7, respectively, a period between the time t3 and the time t4 represents a signal writing period during which a signal voltage Va corresponding to display data is written in the organic EL element OLED provided in the drive circuit. A period after the time t4 represents a light emitting period (display period) during which the organic EL element OLED displays the display data. A period before the time t3 represents a light emitting period during which the organic EL element OLED displays previous display data. In FIG. 4, a voltage of the signal line SIG is sequentially changed. The respective voltages represent the respective signal voltages of the plurality of pixel circuits PC (drive circuits) that sequentially writes the signal, and the plurality of pixel circuits corresponds to the pixel circuits PC aligned in a row in the longitudinal direction in FIG. 2. Before the time t3, the first control line φ1 is maintained at a low voltage V_{L} which is an off-state voltage, and the second control line φ2 is maintained at a high voltage V_{H} which is an on-state voltage. In this example, the high voltage V_{H} is a high voltage sufficient to turn on the transistor. That is, the transistor NT2 is maintained in an off-state, and the transistor

NT3 is maintained in an on-state. Also, the node N1 is maintained at a voltage Vₐₚ before writing, and the node N2 is maintained at a voltage V₁ₚ. At the time t3 when the signal writing period starts, the voltage of the first control lines φ1 changes from the low voltage V_{L} to the high voltage V_{H} which is the on-state voltage. With this change, the transistor NT2 turns on. At the time t3, the transistor NT3 is in the on-state. Also, at the time t3, the signal voltage Vₐ corresponding to the display data which is displayed by the organic EL element OLED in a subsequent light emitting period is applied to the signal line SIG. Hence, the gate of the transistor NT1 (node N1) is connected to the signal line SIG maintained at the signal voltage Vₐ through the transistor NT2 which is in the on-state. The two capacitors C1 and C2 are charged or discharged, and the node N1 changes from the voltage Vₐₚ to the signal voltage Vₐ. That is, the signal voltage Vₐ to be applied to the signal line SIG is applied to the gate of the transistor NT1. Since the second control line φ2 is maintained at the high voltage V_{H}, the transistor NT3 is maintained in the on-state, and the node N2 is maintained at the voltage V. In this situation, if the voltage of the source of the transistor NT1 (node N2) is higher than a diode threshold voltage of the organic EL element OLED, a current that flows in the transistor NT1 also flows into the organic EL element OLED in correspondence with the voltage (signal voltage Vₐ) of the node N1 to emit a light.

At a time is which is a time between the time t3 and the time t4, that is, a time after a given time elapses from the time t3, the voltage of the second control lines φ2 changes from the high voltage V_{H} (on-state voltage) to the low voltage V (off-state voltage), the transistor NT3 turns off, and a current supply to the organic EL element OLED stops. Then, the two capacitors C1 and C2 are charged or discharged, the voltage at the node N2 rises from the voltage V₁ₚ to a voltage (Vₐ-Vₜₕ), and the transistor NT1 turns off.

At the time t4 when the light emitting period starts, the voltage of the first control lines (pi changes from the high voltage V_{H} (on-state voltage) to the low voltage V_{L} (off-state voltage), and the voltage of the second control lines φ2 changes from the low voltage V_{L} (off-state voltage) to the high voltage V_{H} (on-state voltage). With those changes, the transistor NT2 turns off, and the transistor NT3 turns on. When the transistor NT2 becomes in the off-state, the node N1 becomes a floating node, and the node N2 is connected to an anode (node N3) of the organic EL element OLED. In this situation, if the voltage at the node N2 is higher than the diode threshold voltage of the organic EL element OLED, a current flows into the organic EL element OLED, and the voltage at the node N2 drops to a voltage V₁. In this situation, with a change in the voltage at the node N2, the voltage at the node N1 changes through the capacitor C2. When it is assumed that the changed voltage at the node N1 is Vₐ₁, the voltage Vₐ₁ is applied to the gate of the transistor NT1 in the light emitting period. Since a current corresponding to the voltage Vₐ₁ flows in the transistor NT1, and the current flows in the organic EL element OLED, the organic EL element OLED emits the light of a light emission quantity corresponding to the amount of current, for displaying. In this example, a timing at which the first control lines φ1 change from the high voltage V_{H} to the low voltage V_{L}, and a timing at which the second control lines φ2 change from the low voltage V_{L} to the high voltage V_{H} are equal to each other, and set to the time t4. However, the present invention is not limited to the above configuration. If it takes time to stably change the transistor NT2 from the on-state to the off-state, the first control lines φ1 change from the high voltage V_{H} to the low voltage V_{L}, and the transistor NT2 sufficiently becomes in the off-state. Thereafter, the second control lines φ2 may change from the low voltage V_{L} to the high voltage V_{H}. When the transistor NT3 becomes in the on-state, a current flows into the organic EL element OLED to start the light emitting period. Also, in the drive for allowing the organic EL elements OLED of the plural pixel circuits PC provided in the display area DP to start the light emission at the same time, the plurality of second control lines φ2 may change from the low voltage V_{L} to the high voltage V_{H} at the same time.

The advantages obtained by the drive circuit according to the first embodiment will be described below. In this example, the voltage Vₐ₁ at the node N1 is represented by an Equation 1 described below.

Vₐ₁−Vₐ−(Vₐ−Vₜₕ)×{C2/(C1+C2)}

Equation 1 is rearranged into Equation 2 described below.

Vₐ₁−Vₐ×{C1/(C1+C2)}+Vₜₕ×{C2/(C1+C2)}

Equation 2 obtains two advantages described below by the drive circuit according to the first embodiment. A first advantage resides in that the signal voltage Vₐ is compressed to {C1/(C1+C2)} times. When the display device is subjected to higher definition, and an area that can be occupied by each of the pixel circuits is reduced, an element size of the transistor NT1 which is the drive transistor has to be reduced (a channel length 1 has to be shortened) . In this case, since a current efficiency for a voltage change rises, an available signal voltage range is reduced. With this reduction, when the range of the signal voltage supplied from the external (signal line drive circuit XDV) is reduced, since gradation voltages corresponding to the number of gradations are allocated to the range, a difference in voltage between the adjacent gradation values is reduced, and a gradation expression becomes difficult. However, in the present invention, a significance that the range of the signal voltage applied from the external can increase is created. For example, when two capacitors are equal to each other (C1=C2), an effective gate voltage of the transistor NT1 is a half (½ times) of the signal voltage Vₐ.

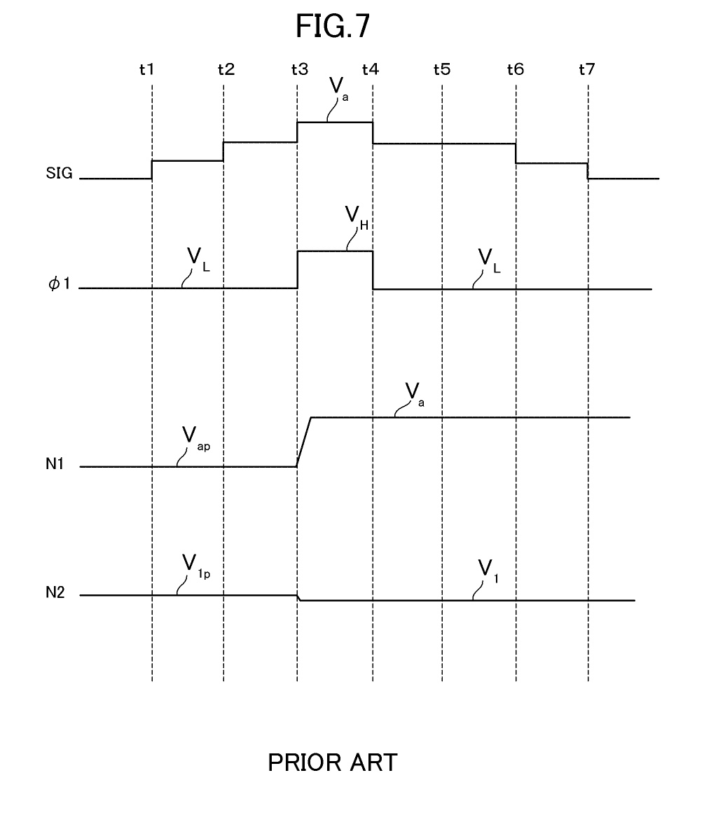

A second advantage resides in that the threshold voltage Vₜₕ is corrected by a ratio of {C2/(C1+C2)}. In the drive circuit according to the first embodiment, the threshold voltage Vₜₕ cannot be completely corrected. However, the threshold voltage Vₜₕ can be corrected at a given ratio, unlike the drive circuit in the related art illustrated in FIG. 7. Therefore, even if a plurality of pixel circuits are arranged two-dimensionally, a variation of the threshold voltage Vₜₕ is corrected at the same ratio. For example, when two capacitors are equal to each other (C1=C2), the threshold voltage Vₜₕ and ½ of that variation can be corrected.

The two capacitors C1 and C2 can be determined from the viewpoints of the first advantage and the second advantage. That is, when an increase in the range of the signal voltage, which is the first advantage, is prioritized, the capacitor C1 may be set to be larger than the capacitor C2. Also, when a correction to the threshold voltage Vₜₕ, which is the second advantage, is prioritized, the capacitor C2 may be set to be larger than the capacitor C1. In fact, it is desirable that both of the first advantage and the second advantage are obtained with a good balance, and it is desirable that the capacitor C1 is substantially equal to the capacitor C2. In the present specification, “substantially equal” means that a difference between the capacitor C1 and the capacitor C2 falls within ±10% of the capacitor C2 (or the capacitor C1), and it is more desirable that the capacitor C1 is equal to the capacitor C2.

### Second Embodiment

A display device according to a second embodiment of the present invention is identical in structure with the display device of the first embodiment except for a difference in the configuration of the drive circuit of the light emitting element. Also, the same is applied to the drive method for the light emitting element.

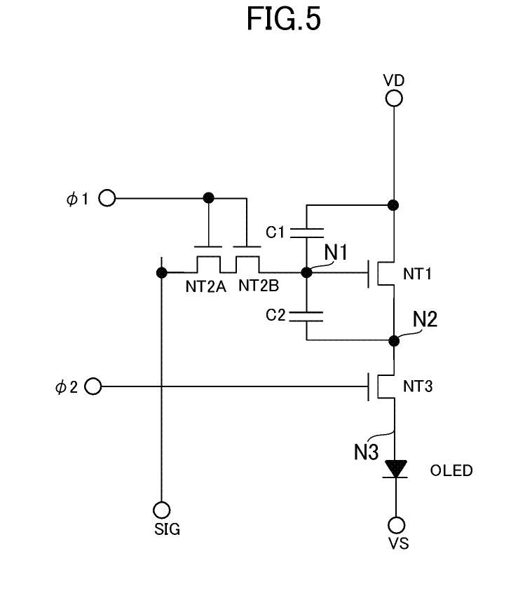

FIG. 5 is a circuit diagram of a drive circuit according to the second embodiment. The drive circuit according to the first embodiment illustrated in FIG. 3 includes the transistor NT2 which is the first switching element whereas the first switching element is configured by a transistor having a double-gate structure (having two gate electrodes) in the drive circuit according to the second embodiment. In FIG. 5, two transistors NT2A and NT2B which are connected in series with each other are illustrated as the first switching element. In the other configuration, the drive circuit according to the second embodiment is identical with the drive circuit according to the first embodiment. Note that the present invention is not limited to the double-gate structure. The first switching element may be configured by a transistor having a multi-gate structure (having a plurality of gate electrodes)

In a light emitting period, the transistor NT2 is in the off-state, and the node N1 represents a floating node. On the other hand, since the voltage to be applied to the signal lines SIG changes according to the display data of the corresponding pixel circuit PC, a leakage current has the potential to flow into the transistor NT2. When the leakage current flows in the transistor NT2, since a voltage at the node N1 (the gate of the transistor NT1) changes, a display quality is degraded. In particular, when the transistor NT2 is formed of a low-temperature polysilicon TFT, the leakage current is problematic. In the drive circuit according to the second embodiment, the first switching element is configured by the transistor having the double-gate structure, to thereby suppress the leakage current during the light emitting period. As a result, the stabilization of the gate voltage of the transistor NT1 can be realized, and an image failure such as smear can be reduced.

The drive circuit, the display device, and the drive method according to the embodiment of the present invention have been described above. In this embodiment, three transistors provided in the drive circuit are each configured by the n-type MOS-TFT (having a common polarity) , but the present invention is not limited to this configuration. For example, a part or all of the three transistors provided in the drive circuit may be configured by a p-type MOS-TFT, or may be configured by another element.

When the drive transistors are each configured by the p-type MOS-TFT, the drain and the source of the drive transistor are located on the second reference voltage VS side and the first reference voltage VD side, respectively. Hence, the arrangement of the first capacitor and the second capacitor is also turned upside down with the arrangement illustrated in FIG. 3 (the first capacitor is located on a lower side whereas the second capacitor is located on an upper side) . Further, the arrangement of the second switching element is arranged on the first reference voltage VD side of the drive transistor, unlike the arrangement illustrated in FIG. 3.

Also, when the first switching element (second switching element) is configured by the p-type MOS-TFT, the on-state voltage becomes the low voltage V_{L}, and the off-state voltage becomes the high voltage V_{H}. Hence, the voltage applied to the first control line φ1 (the second control line φ2) is opposite in phase to the voltage illustrated in FIG. 4. That is, the high voltage V_{H} is replaced with the low voltage V_{L}, and the low voltage V_{L} is replaced with the high voltage V_{H}. That is, in this example, the low voltage V_{L} is low sufficient to turn on the transistor.

In the embodiments, the organic EL element OLED has been described as an example of the light emitting element. However, the present invention is not limited to this configuration, but the drive circuit can be extensively applied to the drive circuit for the light emitting element having the light emission quantity controlled according to the amount of current flowing therein. The drive circuit according to the present invention is provided in the display device, to thereby realize the downsized display device meeting the high definition. However, the drive circuit according to the present invention can be applied to other devices without being limited to the display devices.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A drive circuit, comprising;
a first power line and a second power line that two different reference voltages are applied to, respectively;
a light emitting element that is disposed between the first power line and the second power line, and allows a current to flow therein to emit a light;
a drive transistor that is disposed between the first power line and the second power line, and controls the amount of current flowing into the light emitting element;
a first capacitor that is electrically connected between a gate and one of a source and a drain of the drive transistor;
a second capacitor that is electrically connected between the gate and the other of the source and the drain of the drive transistor;
a first switching element that is electrically connected to the gate of the drive transistor, and turns on during a signal writing period to supply a signal voltage to the gate of the drive transistor; and
a second switching element that is disposed between the first power line and the second power line, wherein the drive transistor, the second switching element, and the light emitting element are connected in series.

2. The drive circuit according to claim 1,
wherein the second switching element is in an on-state when the signal writing period starts, turns off a given time after the signal writing period starts, and again turns on in a light emitting period.

3. The drive circuit according to claim 1,
wherein a difference between the first capacitor and the second capacitor falls within ±10% of the second capacitor.

4. The drive circuit according to claim 1,
wherein the first switching element is a thin film transistor having a plurality of gate electrodes.

5. The drive circuit according to claim 1,
wherein the drive transistor, the first switching element, and the second switching element have a common polarity.

6. A display device, comprising the drive circuit according to claim 1 in a display region.

7. A method of driving a drive circuit including;
a first line and a second line that two different reference voltages are applied to, respectively;
a light emitting element that is disposed between the first power line and the second power line, and allows a current to flow therein to emit a light;
a drive transistor that is disposed between the first power line and the second power line, and controls the amount of current flowing into the light emitting element;
a first capacitor that is electrically connected between a gate and one of a source and a drain of the drive transistor;
a second capacitor that is electrically connected between the gate and the other of the source and the drain of the drive transistor;
a first switching element that is electrically connected between the gate of the drive transistor and a signal line; and
a second switching element that is disposed between the first power line and the second power line, wherein the drive transistor , the second switching element, and the light emitting element are connected in series,
wherein the second switching element is in an on-state when the signal writing period starts,
wherein the first switching element turns on, and applies a signal voltage to be applied to the signal line to the gate of the drive transistor during the signal writing period,
wherein the second switching element turns off a given time after the signal writing period starts, and
wherein the first switching element turns off, and the second switching element turns on in response to a light emitting period.
